(19) United States
(12) Patent Application Publication
(10) Pub. No.: US 2024/0250579 A1
(43) Pub. Date: Jul. 25, 2024

(54) MOTOR SUPPORT STRUCTURE

(71) Applicant: TOYOTA JIDOSHA KABUSHIKI KAISHA, Toyota-shi (JP)

(72) Inventor: Eita HAMADA, Seto-shi (JP)

(73) Assignee: TOYOTA JIDOSHA KABUSHIKI KAISHA, Toyota-shi (JP)

(21) Appl. No.: 18/532,280

(22) Filed: Dec. 7, 2023

(30) Foreign Application Priority Data
Jan. 23, 2023 (JP) 2023-008251

(51) Int. Cl. H02K 5/24; H02K 1/18; H02K 1/20

(52) U.S. Cl. CPC H02K 5/24; H02K 1/185; H02K 1/20

(57) ABSTRACT

A motor support structure includes a case and a ring portion. The ring portion includes an inner cylinder ring portion that is in surface contact with an outer peripheral surface of a stator, an outer cylinder ring portion that is concentrically located at a predetermined distance on an outer periphery of the inner cylinder ring portion and whose outer peripheral surface is in surface contact with the case, and a plurality of partition portions located between the inner cylinder ring portion and the outer cylinder ring portion at predetermined intervals in a circumferential direction of the ring portion and connecting the inner cylinder ring portion and the outer cylinder ring portion. The partition portions are arranged on the outer peripheral side of a specific one of the three phases of the motor.

### CROSS-REFERENCE TO RELATED APPLICATION

This application claims priority to Japanese Patent Application No. 2023-008251 filed on Jan. 23, 2023, incorporated herein by reference in its entirety.

### BACKGROUND

### 1. Technical Field

The present disclosure relates to structures for supporting a stator of a motor in a fixing member such as a case.

### 2. Description of Related Art

Japanese Unexamined Patent Application Publication No. 2010-246259 (JP 2010-246259 A) discloses a fixing structure for a stator that is intended to apply a necessary tightening load to the stator while reducing an increase in iron loss due to an increase in compressive stress. In the structure of JP 2010-246259 A, the stator of a motor is fixed to a case via an outer cylinder ring. A stator core of the stator is composed of a plurality of arc-shaped core segments joined into an annular shape, and the stator core is fastened by shrink fitting in such a manner that the outer peripheral surface of the stator core is in surface contact with the inner peripheral surface of the outer cylinder ring. The outer cylinder ring is fixed to the case by being fitted into the case. The outer cylinder ring is formed in a cylindrical shape. The diameter of the inner peripheral surface of the outer cylinder ring is substantially the same, but the diameter of the outer peripheral surface of the outer cylinder ring is smaller in its intermediate portion in the axial direction than in its remaining portion. Specifically, the outside diameter of the outer cylinder ring is the same in its both end portions in the axial direction of the stator, but is smaller in its intermediate portion in the axial direction of the stator than in the both end portions. The outer cylinder ring is housed in the case and is fixed at a distance to the inner peripheral surface of the case. That is, a resin ring for increasing coaxial accuracy between the rotor and the stator is mounted on the outer periphery of the axial end portion of the outer cylinder ring, and the outer cylinder ring is fixed to the case by the resin ring fitted in the case.

JP 2010-246259 A describes that, with this configuration, a relatively large tightening load is applied to the stator by the large-diameter end portions of the outer cylinder ring and this tightening load is large enough to prevent the stator from coming off in case of a collision. Moreover, since the outside diameter of the intermediate portion is smaller than the outside diameter of the both end portions, it is possible to set the minimum tightening load necessary to hold the stator in the rotational direction against the reaction force generated in the stator during rotation of the motor. This can avoid an unnecessary increase in tightening load in the intermediate portion, and can reduce an increase in iron loss of the stator due to compressive stress.

### SUMMARY

When torque is generated in the motor, vibration occurs mainly due to fluctuations in electromagnetic force. This vibration is transmitted to another member via the case, which causes noise. For example, in the structure of JP 2010-246259 A, the outer cylinder ring is housed and fixed inside the case, and the resin ring is interposed between the outer periphery of the axial end portion of the outer cylinder ring and the case. Therefore, the vibration of the motor is transmitted to the case through the outer cylinder ring and the resin ring, which may generate such vibration and noise as described above. Since the fluctuations in electromagnetic force vary depending on the number of poles of the motor etc., the vibration generated in the stator also varies accordingly. That is, there are cases where the magnitude of the generated vibration may vary in the circumferential direction of the outer cylinder ring. As a result, the vibration and noise generated in the case may increase locally.

The present disclosure was made to solve the above technical problem, and it is an object of the present disclosure to provide a motor support structure that can reduce vibration of a case holding a stator and integrated with the stator.

In order to achieve the above object, a motor support structure according to the present disclosure includes: a case that houses and holds a motor, the motor being a three-phase alternating current motor in which a rotor configured to rotate by a magnetic force is located inside a stator having a plurality of pairs of magnetic poles; and a ring portion that is in close contact with an outer peripheral surface of the stator and an inner peripheral surface of the case and fills between the stator and the case. The motor support structure is characterized by the following.

The ring portion includes
an inner cylinder ring portion that is in surface contact with the outer peripheral surface of the stator,
an outer cylinder ring portion that is concentrically located at a predetermined distance on
an outer periphery of the inner cylinder ring portion and whose outer peripheral surface is in surface contact with the case, and
a plurality of partition portions located between the inner cylinder ring portion and the outer cylinder ring portion at predetermined intervals in a circumferential direction of the ring portion and connecting the inner cylinder ring portion and the outer cylinder ring portion. The partition portions are located on portions of an outer periphery of the motor that correspond to a specific one of three phases of the motor.

In the present disclosure,

the number of the partition portions may be the number of pole pairs multiplied by a power of 2, the number of the pole pairs being the number of the pairs of magnetic poles of the motor, and
the partition portions may be located at positions symmetrical with respect to a rotation center of the motor.

In the present disclosure, the number of the partition portions may be the same as the number of the portions of the motor that correspond to the specific one phase.

In the present disclosure, the ring portion may have clearance between the inner cylinder ring portion and the outer cylinder ring portion in a radial direction, and the clearance may be divided by the partition portions in the radial direction into channels for cooling the motor.

In the present disclosure, each of the partition portions may have a bent portion that is bent in the circumferential direction of the ring portion.

In the present disclosure,

the motor may be a three-phase alternating current motor,
the stator may include
a plurality of teeth protruding radially inward from an inner peripheral surface of the stator with predetermined clearance between the teeth, and
a plurality of slots each of which is the clearance between two adjacent ones of the teeth, the specific one phase may be a U-phase,
fastening between the stator and the ring portion and fastening between the case and the ring portion may be both shrink fitting, and a circumferential width of each of the partition portions may be equal to a sum of a length in a width direction of one tooth and a total length in a width direction of two slots.

According to the motor support structure of the present disclosure, the three-phase alternating current inner rotor motor having the plurality of pairs of magnetic poles is provided with the ring portion that is in close contact with the outer peripheral surface of the stator and the inner peripheral surface of the case and fills between the stator and the case. The ring portion includes: the inner cylinder ring portion that is in surface contact with the outer peripheral surface of the stator; the outer cylinder ring portion that is in surface contact with the inner peripheral surface of the case; and the partition portions connecting the inner cylinder ring portion and the outer cylinder ring portion. The partition portions are located on the portions of the outer periphery of the motor that correspond to the specific one of the three phases of the motor. During driving and power generation of the motor, fluctuations in electromagnetic force occur in the motor due to changes in current flowing in each coil. Due to such fluctuations in electromagnetic force, vibration components that are different for each phase of the motor are generated in the stator regularly according to the number of poles of the motor and transmitted to the case via the ring portion. Since the partition portions of the ring portion are located on the portions of the outer periphery that correspond to the specific one phase, the magnitude and direction of the vibration that is transmitted to the case are less likely to vary among the partition portions. This reduces the possibility that the vibrations generated in the case may combine or resonate to cause a local increase in vibration, and prevents or reduces generation of noise due to such a vibration.

When the number of the partition portions is the number of the pairs of magnetic poles of the stator multiplied by a power of 2, it is possible to further effectively reduce the vibration that is transmitted to the case or the variation in level of the vibration. In particular, when the number of the partition portions is the same as the number of the portions of the stator that correspond to the specific one phase, the vibration mainly caused by displacement of the specific magnetic pole is only transmitted to the case. Therefore, it is possible to further reduce the vibration that is transmitted to the case and the variation in level of the vibration, and it is possible to further reduce a local increase in vibration and noise.

Even when the partition portions form the channels for cooling the motor, it is possible to reduce a local increase in vibration and noise in the case by merely changing the circumferential positions of the partition portions in the manner described above. That is, the channels can be formed by the partition portions without reducing the cooling performance of the motor.

When the partition portion has the bent portion, the bent portion is subjected to bending deformation as a radial load is transmitted from the stator toward the ring portion. Since the bent portion absorbs the energy, it is possible to reduce the vibration that is transmitted from the stator to the case via the partition portions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating an example of a motor support structure according to an embodiment of the present disclosure, and is a cross-sectional view of the motor viewed from an axial direction;

FIG. 2 is an explanatory view showing a rotor concretely while omitting a case from the structure shown in FIG. 1;

FIG. 3 is a comparative diagram showing vibration levels generated in a transaxle case with respect to a frequency generated in a stator in a motor support structure according to an embodiment of the present disclosure and a motor support structure according to a comparative example;

FIG. 4 is a view showing another example of the motor support structure according to the embodiment of the present disclosure, and is an enlarged view showing only one of the plurality of partition portions; and

FIG. 5 is an enlarged view showing still another example of the motor support structure according to the embodiment of the present disclosure, in which only one of a plurality of partition portions is shown.

### DETAILED DESCRIPTION OF EMBODIMENTS

Hereinafter, the present disclosure will be described based on an embodiment shown in the drawings. Note that the embodiments described below are merely examples of a case where the present disclosure is embodied, and are not intended to limit the present disclosure.

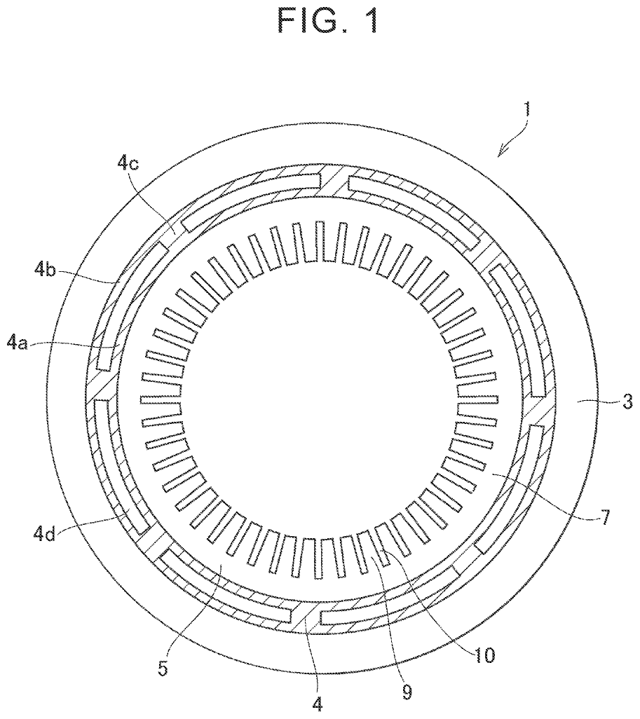

FIG. 1 shows an example of a motor support structure 1 according to an embodiment of the present disclosure. In the example shown in FIG. 1, a motor support structure 1 is applied to a vehicle (not shown), and the motor 2 is supported by a transaxle case 3 of the vehicle. The transaxle case 3 is a case in which, on a power transmission path of a vehicle, a transmission and a differential gear provided between a driving force source such as an engine or a motor 2 and an output-side member such as a driving wheel (not shown) are integrated to accommodate a transaxle. As shown in FIG. 1, a motor 2 is supported inside a transaxle case 3 formed in a cylindrical shape via a ring portion 4. The vehicle may be a vehicle including the motor 2 as a driving force source, such as a conventionally known battery electric vehicle or hybrid electric vehicle.

The motor 2 is a three-phase AC motor 2 in which a rotor 6 rotating by a magnetic force is disposed inside a stator 5 having a plurality of pairs of magnetic poles. The motor 2 is configured to change the magnetic field by changing the current flowing through the stator coil of the stator 5 so as to generate a torque corresponding to the current in the rotor 6. The motor 2 is an inner rotor type motor 2, and has a function as a generator capable of generating electric power for energy regeneration as well as assisting or imparting a driving force of the vehicle. The motor 2 is a three-phase AC type 8-pole motor including a stator 5 having three-phase coils and a rotor 6 disposed on the inner peripheral side of the stator 5.

The stator 5 is a stator of the motor 2, and is a cylindrical member disposed between the stator and the outer peripheral side of the rotor 6 with predetermined clearance in the radial direction, which is also referred to as an air gap. The stator 5 includes a stator core 7 formed of an electromagnetic steel sheet and a stator coil (not shown) attached to the stator core 7. The stator core 7 is formed by laminating a plurality of electrical steel sheets formed in an annular shape and connecting them in the axial direction by, for example, caulking.

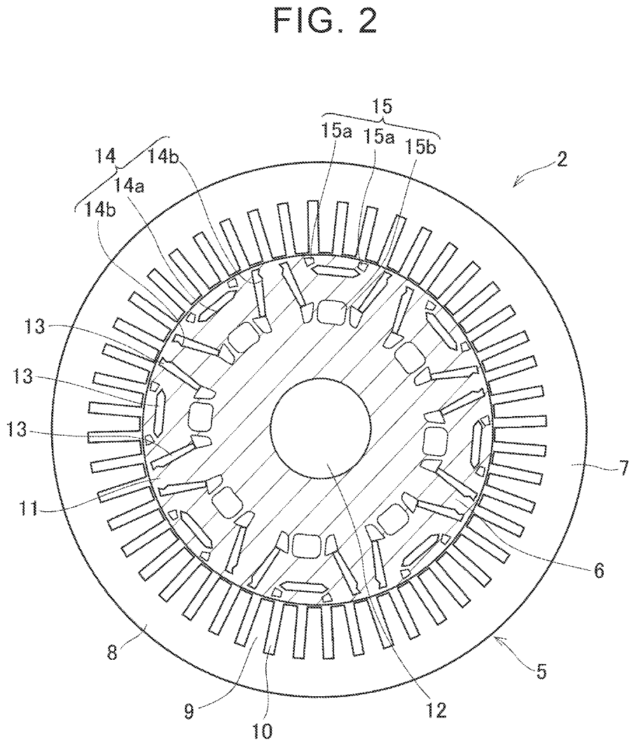

As shown in FIG. 1, the stator core 7 includes an annular back yoke (core back) 8 and a plurality of teeth 9 protruding radially inward from an inner peripheral portion of the back yoke 8. The plurality of teeth 9 are formed at regular intervals with a predetermined clearance in the circumferential direction of the stator core 7, and a slot 10 is formed between two adjacent teeth 9. In order to simplify the drawings, only one of the plurality of teeth 9 and the slot 10 is denoted by reference numerals in FIGS. 1 and 2.

The slot 10 has an opening shape extending in the radial direction of the stator core 7 as a longitudinal direction, and is provided at equal intervals in the circumferential direction according to the plurality of teeth 9. A stator coil is accommodated in the slot 10. Insulating paper for insulating the stator core 7 and the stator coil is disposed inside the slot 10 as necessary.

The stator coil includes a U-phase coil, a V-phase coil, and a W-phase coil, and is mounted in the slot 10. The stator coil is formed by electrically connecting segment coils (not shown) inserted in a plurality of layers stacked in the radial direction inside the slot 10 of the stator core 7. The segment coil is formed in a U-shaped cross section by bending a single flat wire (not shown). The flat wire is a conductive wire having a rectangular cross section, and the surface of the flat wire is coated with an insulating film such as enamel. Incidentally, the motor 2 shown in FIGS. 1 and 2, the slot 10 is formed at 48 positions, the same phase coils for every six slots 10 in the circumferential direction, for example, segment coils are inserted. Therefore, for example, the tooth 9 to which the U-phase coil is attached may be referred to as a U-phase in the motor 2 or a U-phase in the stator.

Although not shown in the drawings, the conductor connected to the stator coil is electrically connected to the inverter, and is electrically connected from the inverter to the battery by another conductor. The conductor from the inverter is connected to the U, V, and W terminals corresponding to the U, V, and W phases, respectively. In the inverter, an operation of an accelerator pedal or a brake pedal of the driver is detected by a sensor, and information indicating an operation state thereof is communicated to the inverter as an electric signal via an electronic control device. When the inverter receives the electric signal, the inverter instructs the battery to measure the amount of electric power, converts the direct current from the battery into an alternating current, and supplies the alternating current to the motor 2.

The rotor 6 is a rotor of the motor 2, and is a cylindrical member disposed with predetermined clearance between the rotor and the inner peripheral side of the stator 5. As shown in FIG. 2, the rotor 6 includes a rotor core 11 formed by laminating a plurality of electromagnetic steel sheets, a shaft hole 12 passing through the rotor core 11, a plurality of magnet holes 14 for embedding the plurality of permanent magnets 13, and a plurality of flux barriers 15 that are holes for reducing leakage of magnetic flux from the permanent magnets 13. In order to simplify the drawings, in FIG. 2, a plurality of permanent magnets 13, a plurality of magnet holes 14, and a plurality of flux barriers 15 are partially labeled.

The shaft hole 12 is a through hole for fitting a rotor shaft (not shown) that rotates integrally with the rotor core 11, and is formed at a center position of the rotor core 11. The rotor shaft is connected so as to apply torque to, for example, wheels of the vehicle. The plurality of magnet holes 14 is a hole into which the permanent magnet 13 is inserted, the first magnet hole 14a which is formed so as to extend in the circumferential direction at the outer edge of the rotor core 11, the first magnet hole 14a is arranged on both sides in the circumferential direction, a pair of second magnet holes 14b which are provided so as to extend in the radial direction of the rotor core 11.

The flux barrier 15 is provided to reduce leakage of the magnetic flux from the permanent magnet 13 to the side surface of the rotor 6. The flux barrier 15 includes a pair of first flux barrier 15a formed adjacent to the first magnet hole 14a and a second flux barrier 15b formed adjacent to the second magnet hole 14b. The pair of first flux barrier 15a are formed in the vicinity of both ends of the first magnet hole 14a in the circumferential direction. The second flux barrier 15b is formed between a radially inner end portion of one magnet hole 14b of the pair of second magnet hole 14b and a radially inner end portion of the other magnet hole 14b of the pair of second magnet hole 14b.

The first magnet hole 14a configured as described above, the pair of second magnet holes 14b, the first magnet hole 14a and three permanent magnets 13 inserted into the pair of second magnet holes 14b, the pair of first flux barrier 15a and the second flux barrier 15b are set, one magnetic pole is formed. The magnetic poles are formed so that the S pole and the N pole are alternately arranged in the circumferential direction of the rotor core 11. For example, in the motor 2 shown in FIG. 1, when the set located at the uppermost portion of the rotor core 11 is the N pole, the sets on both sides of the rotor core 11 adjacent to each other in the circumferential direction are the S pole. There are eight sets of motors 2 shown in FIG. 1. That is, in the motor 2 shown in FIG. 1, the number of poles is 8, and therefore the number of pole pairs is 4.

As shown in FIG. 1, the ring portion 4 is interposed between the stator 5 and the transaxle case 3 so as to fix the stator 5 to the transaxle case 3. The ring portion 4 is in close contact with each of the stator 5 and the transaxle case 3, and is integrated by shrink fitting. The ring portion 4 includes an inner cylinder ring portion 4a fitted to the stator 5 by shrink fitting, an outer cylinder ring portion 4b concentrically disposed at a predetermined distance from the outer peripheral side of the inner cylinder ring portion 4a and fitted to the transaxle case 3 by shrink fitting, and a plurality of partition portions 4c extending between the inner cylinder ring portion 4a and the outer cylinder ring portion 4b.

The inner cylinder ring portion 4a is formed so that the length in the axial direction is the same as the length in the axial direction of the stator 5, and covers the entire outer peripheral surface of the stator 5. The outer cylinder ring portion 4b is formed so that the length in the axial direction is the same as the length in the axial direction of the transaxle case 3, and covers the entire inner peripheral surface of the transaxle case 3. The radial clearance between the inner cylinder ring portion 4a and the outer cylinder ring portion 4b serves as a channel 4d for causing oil (not shown) for cooling the motor 2 to flow. The channels 4d are separated by the partition portions 4c. Since the stator 5 and the inner cylinder ring portion 4a are integrated by shrink fitting, the outer peripheral surface of the stator 5 and the inner peripheral surface of the inner cylinder ring portion 4a are in surface-contact. Therefore, the effect of cooling the motor 2 by the oil flowing through the channels is relatively high.

As shown in FIGS. 1 and 2, the plurality of partition portions 4c are formed between the inner cylinder ring portion 4a and the outer cylinder ring portion 4b so as to be spaced apart from each other by a predetermined distance in the circumferential direction of the ring portion 4. Specifically, the plurality of partition portions 4c are equally spaced apart from each other, and each of the plurality of partition portions 4c is formed so as to be located radially outward in the same phase among the three-phase coils in the stator 5. In the embodiment shown in FIG. 1, the partition portion 4c is formed at a position overlapping the radially outer side of the U-phase of the three-phase coil, and the partition portion 4c is provided at a position symmetrical about the rotational center of the motor 2. Specifically, the partition portion 4c is formed radially outward of the eight U-phases arranged at equal intervals among the 16 U-phases in the stator 5. That is, the partition portion 4c is disposed radially outward of the U-phase in which the direction of the current flowing in the U-phase is the same. Further, the length in the circumferential direction (width of the partition portion 4c) of the ring portion 4 of the partition portion 4c is formed to be approximately equal to the length obtained by adding the length in the width direction of the two slots 10 to the length in the width direction of one tooth 9. Note that the U-phase in the motor 2 corresponds to a specific one of the three phases in the embodiment of the present disclosure.

The rotor 6 is rotated by a rotating magnetic field generated by an alternating current flowing in phases different from each other in each coil of the motor 2 configured as described above, and the motor 2 generates torque. At that time, fluctuation of the electromagnetic force is caused by the change of the current flowing through each coil, and as a result, the electromagnetic excitation force is generated so as to vibrate the teeth 9. For example, in the case of a motor as shown in FIG. 1, since four pairs of magnetic pole pairs are formed, an electromagnetic excitation force having a rotational order of an integer multiple of 4 is generated. Since the stator 5 is fastened to the transaxle case 3 via the ring portion 4, the vibration caused by the electromagnetic excitation force is transmitted from the stator 5 to the transaxle case 3. Further, the vibration caused by the variation of the electromagnetic force of the stator 5 becomes regular in accordance with the number of poles of the motor 2, vibration of different components in accordance with each phase of the stator 5 is generated. Specifically, in the case of an 8-pole motor as shown in FIG. 1, in the vicinity of each tooth 9 to which the U-phase coil is mounted, a large vibration may occur in comparison with other portions in the circumferential direction of the stator 5. If the vibrations transmitted to the transaxle case 3 differ from one ring portion 4 to another, there is a possibility that the vibrations of the ring portion 4 and the transaxle case 3 increase locally.

On the other hand, in the motor support structure 1 shown in FIGS. 1 and 2, the partition portion 4 is formed on the radially outer side of a specific one of the three phases of the motor 2. Specifically, the partition portion 4c is formed radially outward of every other U-phase of the plurality of U-phases in the stator. That is, in the stator 5, the partition portion 4c is formed at a position where the vibration caused by the fluctuation of the electromagnetic force is at the same level. The partition portion 4c extends radially and connects the inner cylinder ring portion 4a shrink-fitted to the stator 5 and the outer cylinder ring portion 4b shrink-fitted to the transaxle case 3. Therefore, the magnitude of vibration that is transmitted from the stator 5 to the transaxle case 3 via the ring portion 4 can be suppressed to vary depending on the partition portion 4c. As a result, it is possible to reduce a local increase in vibration generated in the ring portion 4 and the transaxle case 3. Further, it is possible to prevent or reduce generation of noise caused by the vibration.

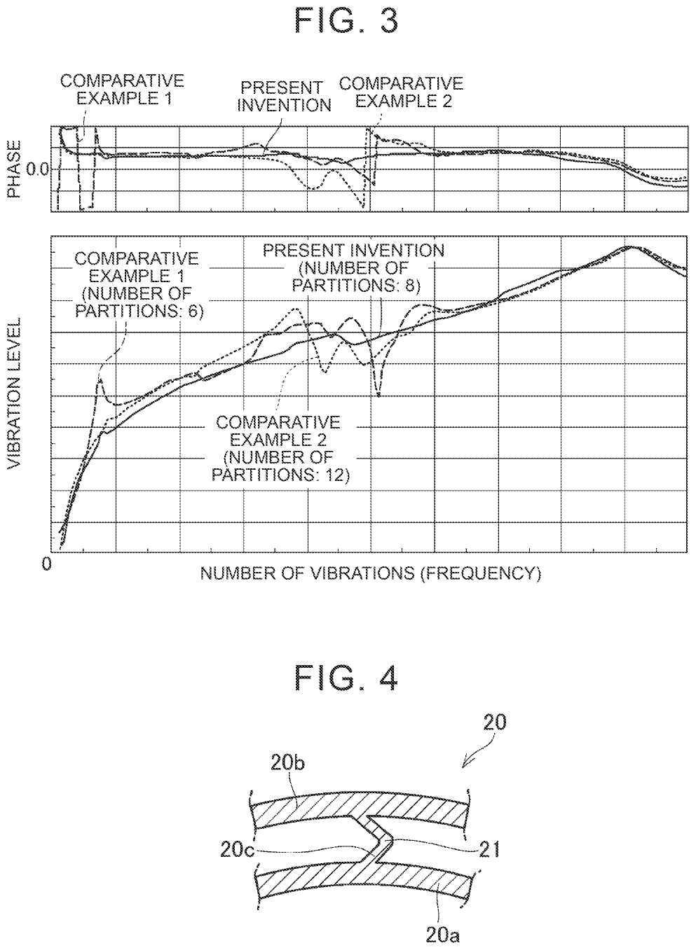

FIG. 3 is a comparison diagram showing the vibration levels generated in the transaxle case 3 according to the frequency between the case where the motor support structure 1 in the embodiment of the present disclosure is applied and the case where the motor support structure in the comparative example is applied. In the comparative example, a comparative example 1 in which the number of the partition portions 4c in the ring portion 4 is 6 and a comparative example 2 in which the number of the partition portions 4c in the ring portion 4 is 12 are illustrated. The structure of the motor 2 in each comparative example is the same as that of the above-described embodiment, and the number of poles is 8 and the motor 2 is of a three-phase AC type. Therefore, the plurality of partition portions 4c in the comparative examples include a partition portion 4c in which the circumferential position is located on the radially outer side of the U-phase of the stator 5, and a partition portion 4c in which the circumferential position is located on the radially outer side of the V-phase or the W-phase.

In the comparative example configured as described above and the embodiment described above, when the output torque of the motor 2 is changed to gradually increase the frequency generated in the motor 2, as shown in FIG. 3, the vibration level increases as the frequency increases in any case. In the process of increasing the frequency gradually, in Comparative Example 1 in which the number of the partition portion 4c is 6, the vibration level temporarily suddenly increases when the frequency is relatively small, and thereafter, the vibration level sometimes suddenly decreases temporarily. In Comparative Example 2 in which the number of the partition portions 4c was 12, the vibration level temporarily suddenly decreased, and the relatively large increase and decrease in the vibration level were repeated in some cases. In the case of the embodiment of the present disclosure, no abrupt change in vibration level as in Comparative Example 1 and Comparative Example 2 was detected. That is, according to the above-described embodiment, the sudden fluctuation of the vibration level transmitted from the stator 5 to the transaxle case 3 via the ring portion 4 is reduced. That is, according to the embodiments illustrated in FIGS. 1 and 2, a local increase in vibration and noise of the transaxle case 3 is prevented or reduced.

Next, a motor support structure according to another embodiment of the present disclosure will be described. In FIG. 4, the periphery of one partition portion 20c among the plurality of partition portions 20c connecting the inner cylinder ring portion 20a and the outer cylinder ring portion 20b of the ring portion 20 is shown in an enlarged manner. In the partition portion 20c shown in FIG. 4, a bent portion 21 in which a central part of the partition portion 20c is bent radially is formed.

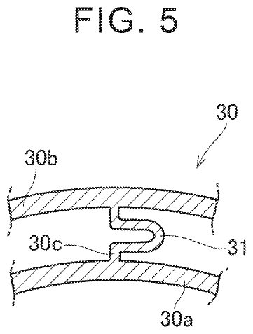

FIG. 5 is a view corresponding to FIG. 4, and is a motor support structure according to still another embodiment of the present disclosure. In the partition portion 30c shown in FIG. 5, a portion having a U-shaped cross section is formed in a central portion in the radial direction of the partition portion 30c. Specifically, the partition portion 30c shown in FIG. 5 is formed by a portion protruding in the radial direction from the inner cylinder ring portion 30a and the outer cylinder ring portion 30b, and a U-shaped curved portion 31 which is formed by bending while bending in the circumferential direction from the protruding portion. The curved portion 31 corresponds to a bent portion in the embodiment of the present disclosure.

In another embodiment of the present disclosure and in another embodiment of the present disclosure, the motor support structure 1 includes a partition portion 4c in which a bent portion 21 or a curved portion 31 is formed at a radial center portion. Therefore, when the stator 5 vibrates due to the electromagnetic excitation force and the vibration in the radial direction in the vibration is transmitted to the inner cylinder ring portion 4a, bending deformation occurs in the bent portion 21 or the curved portion 31. Therefore, mainly radial vibrational components transmitted from the stator 5 can be absorbed or attenuated by the partition portion 4c. Therefore, it is possible to reduce vibrations transmitted from the stator 5 to the transaxle case 3 via the partition portion 4c.

Note that the bent portion 21 or the curved portion 31 may be formed in all of the plurality of partition portions 4c formed in the ring portion 4, or may be formed only in part of the partition portions 4c of the plurality of partition portions 4c. When the bent portion 21 is formed on a part of the partition portion 4c, it is preferable that the position of the partition portion 4c having the bent portion 21 is formed on the diagonal line of the ring portion 4.

Although the embodiments of the present disclosure have been described above, the present disclosure is not limited to the above-described examples, and may be appropriately modified within the scope of achieving the object of the present disclosure. For example, the partition portion 4c, 20c, 30c is not limited to the number shown in FIGS. 1 and 2, and may be formed by the number obtained by multiplying the number of pole pairs of the motor 2 by the power of 2 (that is, the number of pole pairs×2⁽ⁿ⁻¹⁾ (n: natural number)). The partition portions 4c, 20c, 30c can be formed at any positions as long as they are at equal intervals in the circumferential direction of the ring portions 4, 20, and 30. That is, it only needs to be formed on the outer peripheral side of one specific phase in the motor 2.

What is claimed is:

1. A motor support structure comprising:
a case that houses and holds a motor, the motor being a three-phase alternating current motor in which a rotor configured to rotate by a magnetic force is located inside a stator having a plurality of pairs of magnetic poles; and
a ring portion that is in close contact with an outer peripheral surface of the stator and an inner peripheral surface of the case and fills between the stator and the case, wherein:
the ring portion includes
an inner cylinder ring portion that is in surface contact with the outer peripheral surface of the stator,
an outer cylinder ring portion that is concentrically located at a predetermined distance on an outer periphery of the inner cylinder ring portion and whose outer peripheral surface is in surface contact with the case, and
a plurality of partition portions located between the inner cylinder ring portion and the outer cylinder ring portion at predetermined intervals in a circumferential direction of the ring portion and connecting the inner cylinder ring portion and the outer cylinder ring portion; and
the partition portions are located on portions of an outer periphery of the motor that correspond to a specific one of three phases of the motor.

2. The motor support structure according to claim 1, wherein:
the number of the partition portions is the number of pole pairs multiplied by a power of 2, the number of the pole pairs being the number of the pairs of magnetic poles of the motor; and
the partition portions are located at positions symmetrical with respect to a rotation center of the motor.

3. The motor support structure according to claim 1, wherein the number of the partition portions is the same as the number of the portions of the motor that correspond to the specific one phase.

4. The motor support structure according to claim 1, wherein:
the ring portion has clearance between the inner cylinder ring portion and the outer cylinder ring portion in a radial direction; and
the clearance is divided by the partition portions in the radial direction into channels for cooling the motor.

5. The motor support structure according to claim 1, wherein each of the partition portions has a bent portion that is bent in the circumferential direction of the ring portion.

6. The motor support structure according to claim 1, wherein:
the stator includes
a plurality of teeth protruding radially inward from an inner peripheral surface of the stator with predetermined clearance between the teeth, and
a plurality of slots each of which is the clearance between two adjacent ones of the teeth;
the specific one phase is a U-phase;
fastening between the stator and the ring portion and fastening between the case and the ring portion are both shrink fitting; and
a circumferential width of each of the partition portions is equal to a sum of a length in a width direction of one tooth and a total length in a width direction of two slots.
